(19) United States
(12) Patent Application Publication
(10) Pub. No.: US 2026/0205427 A1
(43) Pub. Date: Jul. 16, 2026

(54) SYSTEMS AND METHODS FOR CREATING FEEDBACK FOR A MODEL

(71) Applicant: Comcast Cable Communications, LLC, Philadelphia, PA (US)

(72) Inventor: Yonatan Vaizman, Silver Spring, MD (US)

(21) Appl. No.: 19/018,123

(22) Filed: Jan. 13, 2025

(51) Int. Cl. H04L 51/02; H04L 51/04

(52) U.S. Cl. CPC H04L 51/02; H04L 51/04

(57) ABSTRACT

A method described herein may include receiving a chat session with a plurality of turns, where one or more of the turns may include a prompt and a response, and where the response may include probabilistic output generated by a model. The method may include causing the chat session to be output via a user interface. The method may include receiving a plurality of annotations via the user interface, where one or more of the annotations is associated with the one or more of the turns, and where the one or more annotations may include a categorial annotation and a contextual annotation. The method may include generating a feedback set associated with the one or more of the turns of the chat session. The method may include causing the feedback set to reinforce the model.

### BACKGROUND

Large Language Models (LLMs) have become popular tools for various applications. Typically, an LLM is pre-trained with a large corpus of documents or other sources of training data.

However, improvements are needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

An example method described herein may include receiving a chat session with a plurality of turns, where one or more of the turns may include a prompt and a response, and where the response may include probabilistic output generated by a model. The example method may also include causing the chat session to be output via a user interface. The example method may furthermore include receiving a plurality of annotations via the user interface, where one or more of the annotations is associated with the one or more of the turns, and where the one or more annotations may include a categorial annotation and a contextual annotation. The example method may in addition include generating, using at least a natural language processing (NLP) model and based at least upon the one or more of the annotations, a feedback set associated with the one or more of the turns of the chat session, where the feedback set may include a feedback prompt, a feedback response, and a feedback instruction. The example method may moreover include causing the feedback set to reinforce the model. Other embodiments of this aspect include corresponding computer systems, apparatus, and computer programs recorded on one or more computer storage devices, each configured to perform the actions of the methods.

An example method described herein may include receiving a chat session, where the chat session may include at least one turn, where the at least one turn may include at least a prompt and a response, and where the response may include probabilistic output generated by a model. The example method may also include receiving at least one annotation, where the at least one annotation is associated with the at least one turn, and where an annotation may include at least a categorial annotation and a contextual annotation. The example method may furthermore include generating, based on the at least one annotation, at least one feedback set, where the at least one feedback set may include a feedback prompt, a feedback response, and a feedback instruction. The example method may in addition include causing the at least one feedback set to be inputted to the model to finetune the model. Other embodiments of this aspect include corresponding computer systems, apparatus, and computer programs recorded on one or more computer storage devices, each configured to perform the actions of the methods.

An example method described herein may include receiving a chat session with a plurality of turns, where one or more of the turns may include a prompt and a response, and where the response may include probabilistic output generated by a model. The example method may also include causing the chat session to be output via a user interface. The example method may furthermore include receiving a plurality of annotations via the user interface, where one or more of the annotations is associated with the one or more turns. The example method may in addition include automatically generating, using at least a natural language processing (NLP) model and based at least upon the one or more of the annotations, a feedback set associated with the one or more of the turns of the chat session, where the feedback set may include a feedback prompt, a feedback response, and a feedback instruction. The example method may moreover include causing the feedback set to reinforce the model. Other embodiments of this aspect include corresponding computer systems, apparatus, and computer programs recorded on one or more computer storage devices, each configured to perform the actions of the methods.

An example system described herein may include one or more processors configured to: receive a chat session with a plurality of turns, where one or more of the turns may include a prompt and a response, and where the response may include probabilistic output generated by a model; cause the chat session to be output via a user interface; receive a plurality of annotations via the user interface, where one or more of the annotations is associated with the one or more of the turns, and where the one or more annotations may include a categorial annotation and a contextual annotation; generate, using at least a natural language processing (NLP) model and based at least upon the one or more of the annotations, a feedback set associated with the one or more of the turns of the chat session, where the feedback set may include a feedback prompt, a feedback response, and a feedback instruction; and cause the feedback set to reinforce the model. Other embodiments of this aspect include corresponding computer systems, apparatus, and computer programs recorded on one or more computer storage devices, each configured to perform the actions of the methods.

An example system described herein may include one or more processors configured to: receive a chat session, where the chat session may include at least one turn, where the at least one turn may include at least a prompt and a response, and where the response may include probabilistic output generated by a model; receive at least one annotation, where the at least one annotation is associated with the at least one turn, and where an annotation may include at least a categorial annotation and a contextual annotation; generate, based on the at least one annotation, at least one feedback set, where the at least one feedback set may include a feedback prompt, a feedback response, and a feedback instruction; and cause the at least one feedback set to be inputted to the model to finetune the model. Other embodiments of this aspect include corresponding computer systems, apparatus, and computer programs recorded on one or more computer storage devices, each configured to perform the actions of the methods.

Implementations may include one or more of the following features. The example system where the at least one annotation is automatically created without human interaction. The example system where the at least one annotation is created manually. The example system where the categorical annotation indicates whether a corresponding response may include a positive response or a negative response relative to an associated prompt. The example system where the feedback instruction may include categorical instruction and contextual instruction. The example system where the categorical instruction is based on at least the categorical annotation and the contextual instruction is based on at least the contextual annotation. Implementations of the described techniques may include hardware, a method or process, or a computer tangible medium.

An example system described herein may include one or more processors configured to: receive a chat session with a plurality of turns, where one or more of the turns may include a prompt and a response, and where the response may include probabilistic output generated by a model; cause the chat session to be output via a user interface; receive a plurality of annotations via the user interface, where one or more of the annotations is associated with the one or more turns; automatically generate, using at least a natural language processing (NLP) model and based at least upon the one or more of the annotations, a feedback set associated with the one or more of the turns of the chat session, where the feedback set may include a feedback prompt, a feedback response, and a feedback instruction; and cause the feedback set to reinforce the model. Other embodiments of this aspect include corresponding computer systems, apparatus, and computer programs recorded on one or more computer storage devices, each configured to perform the actions of the methods.

### BRIEF DESCRIPTION OF THE DRAWINGS

The present disclosure will be better understood using the description and accompanying schematic figures, which illustrate several non-limiting aspects by way of example. Based on the description and figures, those skilled in the art will be able to deduce other advantageous characteristics of the pocket.

Other advantages of the present disclosure will appear in the light of the description of the systems and methods illustrated by the drawings.

FIG. 1 shows an example environment in which the methods and systems described herein operate.

FIG. 2 shows an example chat session according to the methods and systems described herein.

FIG. 3 shows an example chat session according to the methods and systems described herein.

FIGS. 4A-4C show example annotations according to the methods and systems described herein.

FIGS. 5A-5C show example annotations according to the methods and systems described herein.

FIG. 6 shows example feedback according to the methods and systems described herein.

FIG. 7 shows a flow diagram of an example method described herein.

FIG. 8 shows a flow diagram of an example method described herein.

FIG. 9 shows a flow diagram of an example method described herein.

### DETAILED DESCRIPTION

The present disclosure relates generally to finetuning large language models (LLMs). Typically, an LLM is first pre-trained with a huge corpus of documents. Another typical practice is instruction-tuning-taking a pre-trained LLM (a base model) and fine-tuning the pre-trained LLM with a much smaller batch of domain-specific (or task-specific) data. The name instruction-tuning reflects that instruction-tuning teaches the LLM to do a specific task, or to follow instructions related to a specific domain (by providing LLM with examples of request-response pairs, or multi-turn conversations).

Both pre-training and instruction-tuning use generic and simple algorithms: teaching the model a language-teaching the model to predict next tokens in a sequence (e.g., the next word in a sentence/paragraph/document). Both pre-training and instruction-tuning typically use data that comprises good examples-to teach the model what sequences are part of the language. The generic and simple algorithms typically lack the ability to learn from bad examples (examples of what is not part of the language, or examples of how not to behave).

The models may be trained on real-world data, which may include a single turn (e.g., query and response) and/or multiple turns such as a chat session. The chat sessions may include turns, wherein each turn has a prompt and a response.

Developing an LLM-based model may involve cycles of improvement. A new version of the model may develop at the end of a cycle. Each version of the model may be tested to measure performance. For example, if a conversational model (a chatbot) is being developed, conversations with the chatbot may be simulated (pretending to be a target user and chatting with a current version of the model). Feedback from the simulated chat may be collected: bugs may be detected, improvements may be suggested, performance may be measured (how good are the responses from the model), risks may be highlighted (generated responses that have hallucinated content, offensive content, confusing content, etc.). Feedback may also be collected after a model is deployed to an actual product. Feedback from deployment may include real scenarios from real users. Feedback may be collected implicitly (for example, used suggestions vs. unused) or explicitly (for example, did the suggestion receive a thumbs up or a thumbs down).

The feedback from simulated environments and deployment may provide desirable feedback for training (reenforcing, fine-tuning, improving, etc.) the model to improve future use. However, if only chat sessions with all positive turns are used to train the model, then a considerable amount of expensively acquired training data may be discarded. The methods and systems described herein allow a model to receive feedback from operation when responses were both good and bad, allowing the model to use all available data obtained during operation of the model to improve.

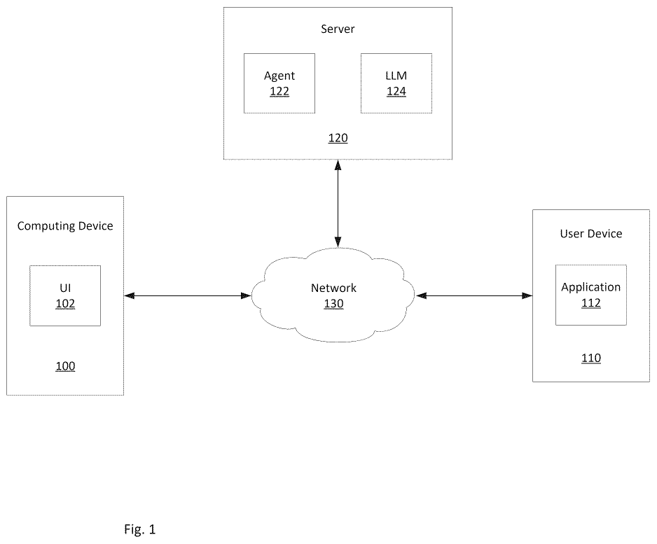

FIG. 1 shows an example environment in which the methods and systems described herein operate. The environment may comprise a computing device 100, a user device 110, a server 120, and a network which facilitates communication among the computing device 100, the user device 110, and the server 120. The computing device may comprise a user interface 102. The user device 110 may comprise an application 112. The server 120 may comprise an agent 122 and a large language model 124.

The computing device 100 may comprise one or more computing devices. The computing device 100 may comprise one or more of a laptop, desktop, smart phone, wearable device, tablet, etc. The user interface 102 may present logs of chat sessions to a user. The user interface 102 may receive annotations from the log of chat sessions via the user interface 102. The annotations may comprise free text input. The annotations may comprise a selection from options. The options may be a binary option, such as good/bad, thumbs up/thumbs down, professional/unprofessional, etc. The selections may be from multiple options, such as good content and good tone, good content but bad tone, good tone but bad content, bad content and bad tone, etc. The annotations may comprise multiple portions, such as a binary option portion and an explanation portion for a selection in the binary option portion. The annotations may be provided to the server 120 via the network for processing into a feedback set for the LLM 124. The computing device 100 may process the annotations into a feedback set and provide the feedback set to the server 120 via the network 130. The computing device 100 may be used by an employee of a service provider. Although shown with the user interface 102, annotation may be performed automatically with a model. Automatic annotation may be performed at the computing device 100, the user device 110 via the application 112, and/or at the server 120.

The user device 110 may comprise one or more of a laptop, desktop, smart phone, wearable device, tablet, etc. The user device 110 may comprise an application 112. The application 112 may comprise a customer service application associated with the service provider. The user device 110 may be associated with a subscriber of the service provider. The application 112 may be in communication with the server 120 via the network 130. The application 112 may allow the subscriber to access the agent 122 and/or the LLM 124. The subscriber may input prompts into the application 112 and receive LLM 124 generate responses to the prompts on the application 112.

The server 120 may comprise one or more computing devices. The server 120 may reside in a cloud computing environment. The agent 122 may comprise a chatbot agent configured to facilitate communication between the LLM 124 and application on user devices, such as the application 112 on the user device 110. The LLM 124 may comprise a conversational model. The server may be associated with the service provider.

The network 130 may comprise a private network. The network 130 may be associated with the service provider. The network 130 may comprise a public network, such as the Internet.

A first user at the user device 110 may initiate a chat session with the application 112. The application 112 may cause initiation of the chat session with the agent 122 on the server 120 via the network 130. The agent 122 may cause prompts entered on the application 112 to be inputted into the LLM 124. The agent 122 may cause responses by the LLM 124 to prompts to be delivered to the application 112 on the user device 110 via the network 130. The server 120 may maintain a log of the chat session. After completion of the chat session, the server 120 may cause the log of the chat session to be delivered to the computing device 100. The user interface 102 of the computing device 100 may present the log of the chat session to a second user. The user interface 102 may receive annotations for one or more turns (prompt and response grouping) in the chat session. The server 120 may receive the annotations for the one or more turns in the chat session. The server 120 may convert the annotations for the one or more turns and associated turns into a feedback set. Alternatively, the computing device 100 may convert the annotations for the one or more turns and associated turns into a feedback set and provide the feedback set to the server 120. The server 120 may use the feedback set as input to the LLM to improve the LLM. The first user at the user device 110 may initiate a second chat session with the application 112. The application 112 may cause initiation of the second chat session with the agent 122 on the server 120 via the network 130. The agent 122 may cause at least a portion of the feedback set to be appended to prompts entered on the application 112 to create appended prompts. The agent 122 may cause appended prompts to be inputted into the LLM 124. The agent 122 may cause responses by the LLM 124 to appended prompts to be delivered to the application 112 on the user device 110 via the network 130.

A first user at the user device 110 may initiate a chat session with the application 112. The application 112 may comprise a customer service application for a service provider, and the first user may be a customer of the service provider. The application 112 may cause initiation of the chat session with the agent 122 on the server 120 via the network 130. The first user may enter a first prompt of “I pay for channel 837, but my television won't display it.” The agent 122 may provide the first prompt to the LLM 124 and receive a first response to the first prompt of “I am sorry to hear that your television service is not working as expected. Have you tried unplugging and plugging the set-top box?”. The agent 122 may cause the first response to be delivered to the application 112 on the user device via the network 130. The first user may enter a second prompt of “How would that help? My other channels are working fine.” The agent 122 may provide the second prompt to the LLM 124 and receive a second response to the second prompt of “Oh, your television is working. Sorry about the misunderstanding. What is the reason you are contacting customer service?”. The agent 122 may cause the second response to be delivered to the application 112 on the user device via the network 130. The first user may disconnect the chat session.

The server 120 may cause a log of the chat session to be delivered to the computing device 100. The user interface 102 of the computing device 100 may present the log of the chat session to a second user. The second user may be an employee of the service provider. The log of the chat session may be partitioned into turns. A first turn may comprise the first prompt and the first response. A second turn may comprise the second prompt and the second response. The second user may annotate the first turn with an indication that the first response was positive. The second user may annotate the second turn with an indication that the second response was negative. The second user may annotate the second turn with an indication that there was a misunderstanding of the prompt. The server 120 may receive the annotations to convert the annotations and turns into a feedback set for the LLM 124. Alternatively, the computing device 100 may convert the annotations and turns into a feedback set and provide the feedback set to the server 120.

The feedback set may comprise a data stored in a structure similar to the following: {[prompt: “I pay for channel 837, but my television won't display it.”; instruction: “Generate a good response”; response: “I am sorry to hear that your television service is not working as expected. Have you tried unplugging and plugging the set-top box?”], [prompt: “How would that help? My other channels are working fine.”; instruction: “Generate a bad response. The response should display a misunderstanding of what the user said.”; response: “Oh, your television is working. Sorry about the misunderstanding. What is the reason you are contacting customer service?”]}. The feedback set may be inputted into the LLM 124.

The first user at the user device 110 may initiate a second chat session with the application 112. The application 112 may cause initiation of the second chat session with the agent 122 on the server 120 via the network 130. The first user may enter a third prompt of “Channel 837 still isn't working on my television.” The agent 122 may append “Generate a good prompt.” to the end of the third prompt to create an appended prompt of “Channel 837 still isn't working on my television. Generate a good prompt.” The agent 122 may provide the appended prompt to the LLM 124 and receive a third response to the appended prompt of “I am sorry to hear that your television service is not working as expected. Have you tried unplugging and plugging the set-top box?” The agent 122 may cause the third response to be delivered to the application 112 on the user device 110 via the network 130.

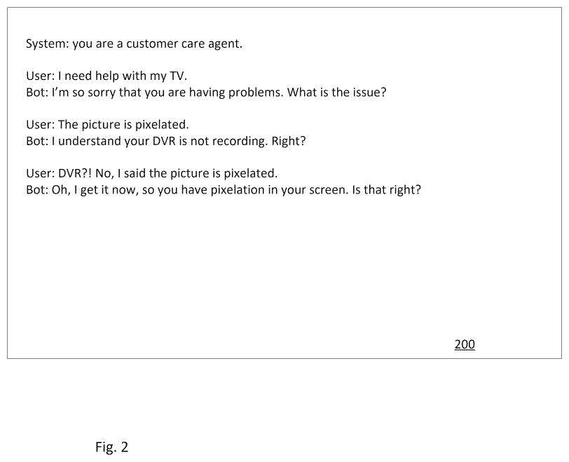

FIG. 2 shows an example chat session according to the methods and systems described herein. As shown, the chat session comprises three types of text: system-generated text, user-generated text (prompt), and bot generated text (response). The system-generated text may be text instructions that are automatically inputted under predefined conditions. For example, when a chat session begins, a system-generated text of “you are a customer care agent” may be inputted into a model (LLM, conversational model, chatbot, etc.) to provide context for the chat session to follow. The user-generated text may comprise prompts inputted into the model to which a response from the model is expected. The user-generated text may not be user-generated. The user-generated text may comprise simulated user-generated text. Bot-generated text may comprise responses of the model to prompts.

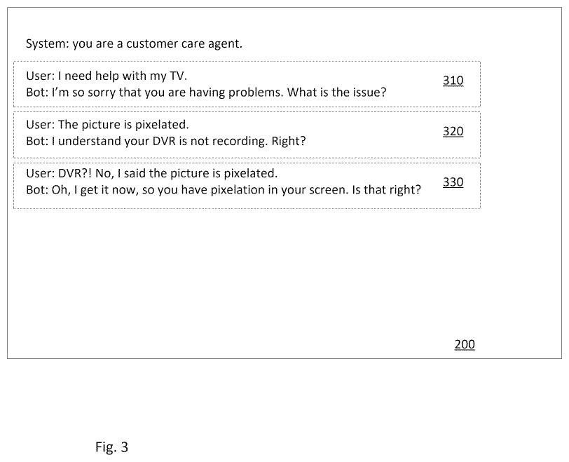

FIG. 3 shows an example chat session according to the methods and systems described herein. In FIG. 3, the chat session of FIG. 2 has been partitioned into turns. A first turn 310 may comprise a first prompt and a first response. The first prompt may comprise “I need help with my TV.” The first response may comprise “I'm so sorry that you are having problems. What is the issue?”. A second turn 320 may comprise a second prompt and a second response. The second prompt may comprise “The picture is pixelated.” The second response may comprise “I understand your DVR is not recording. Right?”. A third turn 330 may comprise a third prompt and a third response. The third prompt may comprise “DVR?! No, I said the picture is pixelated.” The third response may comprise “Oh, I get it now, so you have pixelation in your screen. Is that right?”.

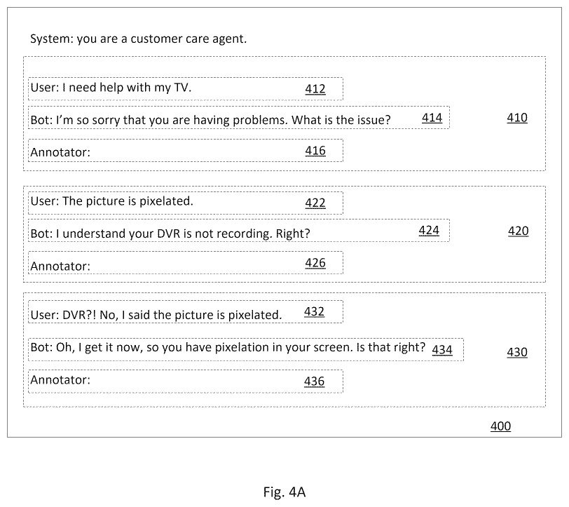

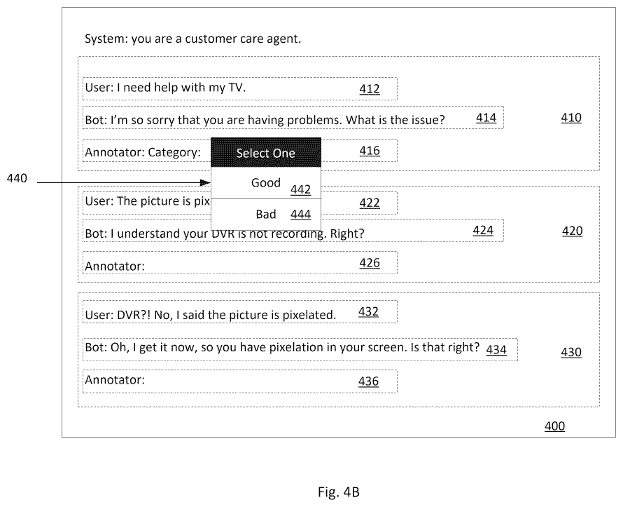

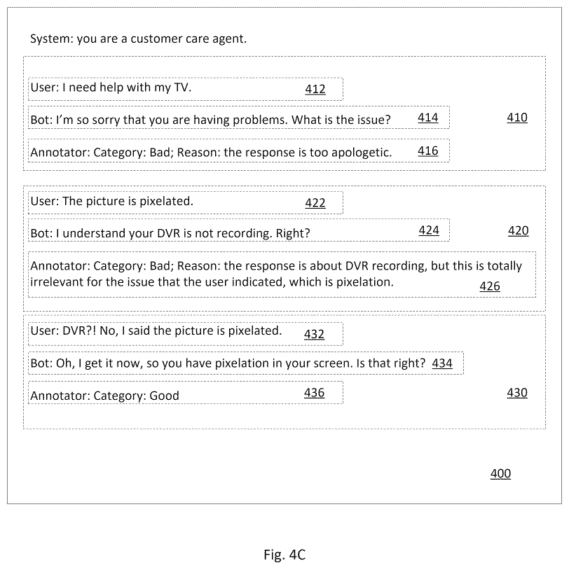

FIGS. 4A-4C show example annotations according to the methods and systems described herein. FIG. 4A shows a screen 400 a user annotating a chat session may see before any annotation data is entered. The screen 400 shows the turns partitioned in FIG. 3, but now each turn comprises an annotator field. The screen comprises a first turn 410 comprises a first prompt 412 (corresponding to the first prompt in FIG. 3), a first response 414 (corresponding to the first response in FIG. 3), and a first annotator field 416. The screen comprises a second turn 420 comprises a second prompt 422 (corresponding to the second prompt in FIG. 3), a second response 424 (corresponding to the second response in FIG. 3), and a second annotator field 426. The screen comprises a third turn 430 comprises a third prompt 432 (corresponding to the third prompt in FIG. 3), a third response 434 (corresponding to the third response in FIG. 3), and a third annotator field 436.

FIG. 4B shows a screen 400 a user annotating a chat session may see while annotation data is being entered. A drop-down menu 440 may appear with options (Good 442 and Bad 444) for annotator field 416. Although shown with two options 442 and 444, more options could be provided. Although shown as a drop-down menu for a category subpart (portion, component, section, part, etc.) of the annotator field 416, input methods could be used to populate any portion of the annotator field 416 or one input method could be used to populate the entire annotator field 416. Although shown with the drop-down menu 440, other input methods are contemplated. For example, a user may freely write text in the annotator fields 416, 426, 436.

FIG. 4C shows a screen 400 a user annotating a chat session may see after annotation data has been entered. The annotator fields 416, 426, 436 may comprise a subpart. For example, annotator fields 416, 426, and 436 comprise a Category subpart. The annotator fields 416, 426, 436 may comprise a conditional subpart—a subpart which exists if one or more condition is satisfied. For example, for the annotator fields 416, 426, and 436 in screen 400, if a Category subpart comprises Bad, then a Reason subpart is provided. The annotator fields 416 and 426 comprise a value of Bad in corresponding Category subparts and Reason subparts. The annotator field 436 comprises a value of Good in a Category subpart and no Reason subpart. As explained above, input may be selected from options or entered as free text input. For the annotator fields 416, 426, 436 in screen 400, values corresponding to the Category subpart are selected from options, while values corresponding to the Reason subpart are entered as free text input.

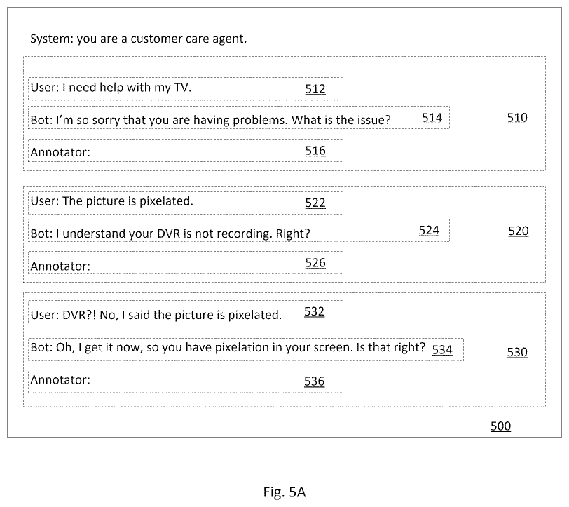

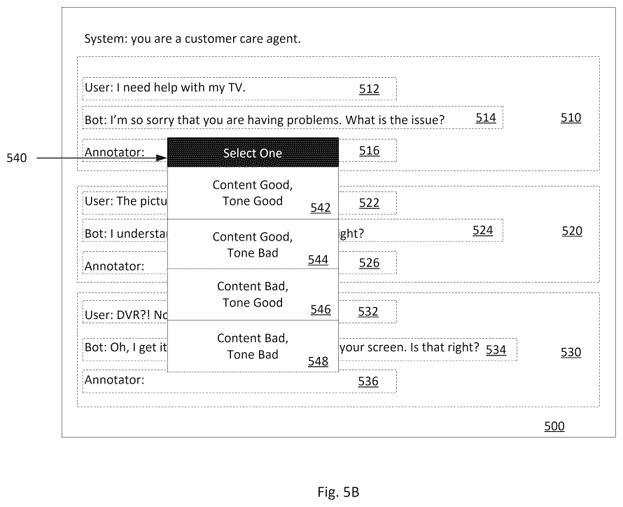

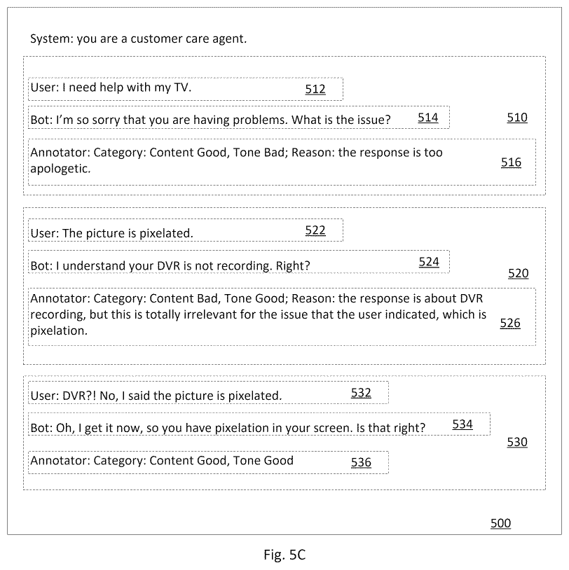

FIGS. 5A-5C show example annotations according to the methods and systems described herein. FIG. 5A shows a screen 500 a user annotating a chat session may see before any annotation data is entered. FIG. 5A is similar to FIG. 4A. The screen 500 shows the turns partitioned in FIG. 3, but now each turn comprises an annotator field. The screen comprises a first turn 510 comprises a first prompt 512 (corresponding to the first prompt in FIG. 3), a first response 514 (corresponding to the first response in FIG. 3), and a first annotator field 516. The screen comprises a second turn 520 comprises a second prompt 522 (corresponding to the second prompt in FIG. 3), a second response 524 (corresponding to the second response in FIG. 3), and a second annotator field 526. The screen comprises a third turn 530 comprises a third prompt 532 (corresponding to the third prompt in FIG. 3), a third response 534 (corresponding to the third response in FIG. 3), and a third annotator field 536.

FIG. 5B shows a screen 500 a user annotating a chat session may see while annotation data is being entered. A drop-down menu 540 may appear with options (Content Good/Tone Good 542, Content Good/Tone Bad 544, Content Bad/Tone Good 546, and Content Bad/Tone Bad 548) for annotator field 516. Although shown with four options 542, 544, 546, 548 less or more options could be provided. Input methods, such as the drop-down menu 540, may cause a subpart of the annotator field 516 to be populated or the entire annotator field 516 to be populated. Although shown with the drop-down menu 540, other input methods are contemplated. For example, a user may freely write text in the annotator fields 516, 526, 536.

FIG. 5C shows a screen 500 a user annotating a chat session may see after annotation data has been entered. The annotator fields 516, 526, 536 may comprise a subpart. For example, annotator fields 516, 526, and 536 comprise a Category subpart. The annotator fields 516, 526, 536 may comprise a conditional subpart—a subpart which exists if one or more condition is satisfied. For example, for the annotator fields 516, 526, and 536 in screen 500, if a Category subpart comprises any state other than Content Good/Tone Good, then a Reason subpart is provided. The annotator field 516 comprises a value of Content Good/Tone Bad in a Category subpart and comprises a Reason subpart. The annotator field 526 comprises a value of Content Bad/Tone Good in a Category subpart and comprises a Reason subpart. The annotator field 536 comprises a value of Content Good/Tone Good in a Category subpart and no Reason subpart. As explained above, input may be selected from options or entered as free text input. For the annotator fields 516, 526, 536 in screen 500, values corresponding to the Category subpart are selected from options, while values corresponding to the Reason subpart are entered as free text input.

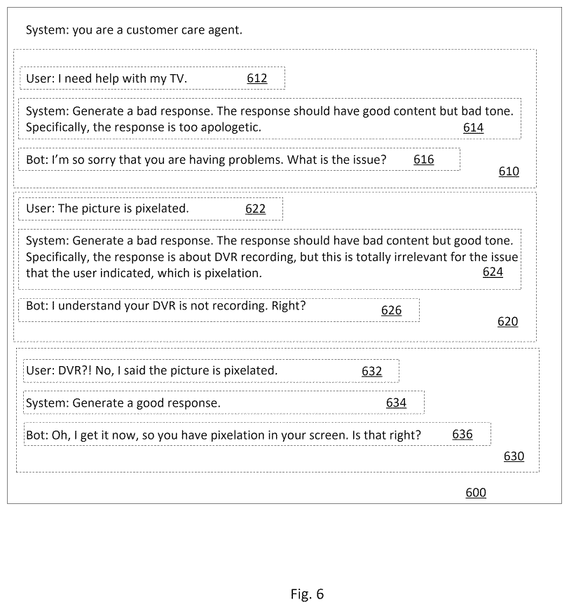

FIG. 6 shows example feedback set according to the methods and systems described herein. The feedback set shown may be given in response to the annotations given in FIG. 4C or FIG. 5C. The example feedback set may be given on a screen 600. The screen 600 may comprise a first turn 610, a second turn 620, and a third turn 630. The first turn 610 may correspond to the first turn of FIG. 2, the first turn 310 of FIG. 3, the first turn 410 of FIGS. 4A-4C, and/or the first turn 510 of FIGS. 5A-5C. The second turn 620 may correspond to the second turn of FIG. 2, the second turn 320 of FIG. 3, the second turn 420 of FIGS. 4A-4C, and/or the second turn 520 of FIGS. 5A-5C. The third turn 630 may correspond to the third turn of FIG. 2, the third turn 330 of FIG. 3, the third turn 430 of FIGS. 4A-4C, and/or the third turn 530 of FIGS. 5A-5C.

The first turn 610 may comprise a first feedback prompt 612, a first feedback instruction 614, and a first feedback response 616. The first feedback prompt 612 may correspond to the first prompt of FIG. 2, the first prompt of FIG. 3, the first prompt 412 of FIGS. 4A-4C, and/or the first prompt 512 of FIGS. 5A-5C. The first feedback instruction 614 may correspond to the first annotator field 416 in FIG. 4C and/or the first annotator field 516 in FIG. 5C. The first feedback response 616 may correspond to the first response of FIG. 2, the first response of FIG. 3, the first response 414 of FIGS. 4A-4C, and/or the first response 514 of FIGS. 5A-5C.

The second turn 620 may comprise a second feedback prompt 622, a second feedback instruction 624, and a second feedback response 626. The second feedback prompt 622 may correspond to the second prompt of FIG. 2, the second prompt of FIG. 3, the second prompt 422 of FIGS. 4A-4C, and the second prompt 522 of FIGS. 5A-5C. The second feedback instruction 624 may correspond to the second annotator field 426 in FIG. 4C and/or the second annotator field 526 in FIG. 5C. The second feedback response 626 may correspond to the second response of FIG. 2, the second response of FIG. 3, the second response 424 of FIGS. 4A-4C, and the second response 524 of FIGS. 5A-5C.

The third turn 630 may comprise a third feedback prompt 632, a third feedback instruction 634, and a third feedback response 636. The third feedback prompt 632 may correspond to the third prompt of FIG. 2, the third prompt of FIG. 3, the third prompt 432 of FIGS. 4A-4C, and the third prompt 532 of FIGS. 5A-5C. The third feedback instruction 634 may correspond to the third annotator field 436 in FIG. 4C and/or the third annotator field 536 in FIG. 5C. The third feedback response 636 may correspond to the third response of FIG. 2, the third response of FIG. 3, the third response 434 of FIGS. 4A-4C, and the third response 534 of FIGS. 5A-5C.

The example feedback set may be given to the model as input. During use (inference generation, output generation, etc.), instruction corresponding to good feedback, such as the third feedback instruction 634 (“Generate a good response.”) may be appended to an end of a prompt. Using training data comprising good responses with a first feedback instruction appended to feedback prompts presented before the good responses on a model combined with forcing the first feedback instruction to be appended to prompts during use of the model increases the chances that a good response will be returned. Additionally, using training data comprising bad responses with a second feedback instruction, which is very different from (may be opposite of) the first feedback instruction, appended to feedback prompts presented before the bad responses on a model combined with forcing the first feedback instruction to be appended to prompts during use of the model decreases the chances that a bad response will be returned.

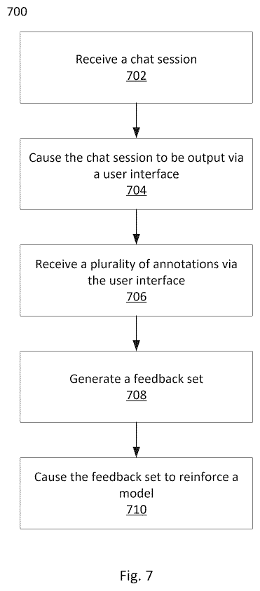

FIG. 7 is a flowchart of an example process 700. In some implementations, one or more process blocks of FIG. 7 may be performed by the computing device 100 and/or the server 120 in FIG. 1.

As shown in FIG. 7, process 700 may include receiving a chat session (block 702). For example, the computing device 100 may receive a chat session. As another example, the server 120 may receive a chat session. The chat session may comprise a plurality of turns. One or more of the turns may include a prompt and a response. The response may include probabilistic output generated by a model. The chat session may comprise data representing a human-model interaction. The chat session may comprise synthetic data. The chat session may comprise data representing an alteration of a human model interaction.

As also shown in FIG. 7, process 700 may include causing the chat session to be output via a user interface (block 704). For example, the computing device 100 may cause the chat session to be output via a user interface. As another example, the server 120 may cause the chat session to be output via a user interface.

As further shown in FIG. 7, process 700 may include receiving a plurality of annotations via the user interface (block 706). For example, the computing device 100 may receive a plurality of annotations via the user interface. As another example, the server 120 may receive a plurality of annotations via the user interface. One or more of the annotations may be associated with the one or more of the turns. The one or more annotations may include a categorial annotation and a contextual annotation. The categorical annotation may indicate whether a corresponding turn comprises a positive response or a negative response. The receiving the plurality of annotations may comprise receiving a free text input via the user interface. The receiving the plurality of annotations may comprise causing a plurality of options to be presented via the user interface; and receiving an indication of a selection of one or more of the plurality of options. The contextual annotation may comprise a commentary relating to the categorical annotation. The categorical annotation may comprise selected from good or bad. The categorical annotation may be selected from professional or unprofessional. The categorical annotation may be selected from helpful or unhelpful. The categorical annotation may be selected from relevant or irrelevant.

As also shown in FIG. 7, process 700 may include generating a feedback set. For example, the computing device 100 may generate a feedback set (block 708). As another example, the server 120 may generate a feedback set. The feedback set may be generated using at least a natural language processing (NLP) model. The feedback set may be based at least upon the one or more of the annotations. The feedback set may be associated with the one or more of the turns of the chat session. The feedback set may include a feedback prompt, a feedback response, and a feedback instruction. The feedback instruction may comprise categorical instruction and contextual instruction. The categorical instruction may be based on at least the categorical annotation. The contextual instruction may be based on at least the contextual annotation. The generating the feedback set may be automatically implemented in response to the receiving the plurality of annotations via the user interface.

As further shown in FIG. 7, process 700 may include causing the feedback set to reinforce the model (block 710). For example, the computing device 100 may cause the feedback set to reinforce the model. As another example, the server 120 may cause the feedback set to reinforce the model.

Process 700 may include receiving a user prompt associated with a second chat session from a user device. For example, the server 120 may receive a user prompt associated with a second chat session from a user device. Process 700 may include appending at least a portion of the feedback instruction to the user prompt associated with the second chat session to create an appended prompt. For example, the server 120 may append at least a portion of the feedback instruction to the user prompt associated with the second chat session to create an appended prompt. Process 700 may include causing the model to generate a second response based on at least the appended prompt. For example, the server 120 may cause the model to generate a second response based on at least the appended prompt. Process 700 may include causing the second response to be transmitted to the user device. For example, the server 120 may cause the second response to be transmitted to the user device.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

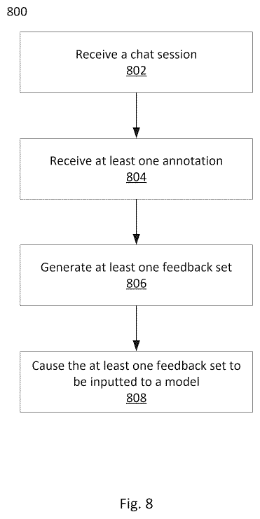

FIG. 8 is a flowchart of an example process 800. In some implementations, one or more process blocks of FIG. 8 may be performed by the computing device 100 and/or the server 120 in FIG. 1.

As shown in FIG. 8, process 800 may include receiving a chat session (block 802). For example, the computing device 100 may receive a chat session. As another example, the server 120 may receive a chat session. The chat session may include at least one turn. The at least one turn may include at least a prompt and a response. The response may include probabilistic output generated by a model. The chat session may comprise data representing a human-model interaction. The chat session may comprise synthetic data. The chat session may comprise data representing an alteration of a human model interaction

As also shown in FIG. 8, process 800 may include receiving at least one annotation (block 804). For example, the computing device 100 may receive at least one annotation. As another example, the server 120 may receive at least one annotation. The at least one annotation may be associated with the at least one turn. An annotation may include at least a categorial annotation and a contextual annotation. The at least one annotation may be automatically created without human interaction. The at least one annotation may be created manually. The categorical annotation may indicate whether a corresponding response comprises a positive response or a negative response relative to an associated prompt. The receiving the at least one annotation may comprise receiving a free text input via a user interface. The receiving the at least one annotation may comprise: causing a plurality of options to be presented via a user interface; and receiving an indication of a selection of one or more of the plurality of options. The contextual annotation may comprise a commentary relating to the categorical annotation. The categorical annotation may be selected from good or bad. The categorical annotation may be selected from professional or unprofessional. The categorical annotation may be selected from helpful or unhelpful. The categorical annotation may be selected from relevant or irrelevant.

As further shown in FIG. 8, process 800 may include generating at least one feedback set (block 806). For example, the computing device 100 may generate at least one feedback set. As another example, the server 120 may generate at least one feedback set. The at least one feedback set may be based on the at least one annotation. The at least one feedback set may include a feedback prompt, a feedback response, and a feedback instruction. The feedback instruction may comprise categorical instruction and contextual instruction. The categorical instruction may be based on at least the categorical annotation. The contextual instruction may be based on at least the contextual annotation. The generating the at least one feedback set may be automatically implemented in response to the receiving the at least one annotation.

As also shown in FIG. 8, process 800 may include causing the at least one feedback set to be inputted to the model (block 808). For example, the computing device 100 may cause the at least one feedback set to be inputted to the model. As another example, the server 120 may cause the at least one feedback set to be inputted to the model. Inputting the at least one feedback set to the model may finetune (train, reinforce, etc.) the model, as described above.

Process 800 may include receiving a user prompt associated with a second chat session from a user device. For example, the server 120 may receive a user prompt associated with a second chat session from a user device. Process 800 may include appending at least a portion of the feedback instruction to the user prompt associated with the second chat session to create an appended prompt. For example, the server 120 may append at least a portion of the feedback instruction to the user prompt associated with the second chat session to create an appended prompt. Process 800 may include causing the model to generate a second response based on at least the appended prompt. For example, the server 120 may cause the model to generate a second response based on at least the appended prompt. Process 800 may include causing the second response to be transmitted to the user device. For example, the server 120 may cause the second response to be transmitted to the user device.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

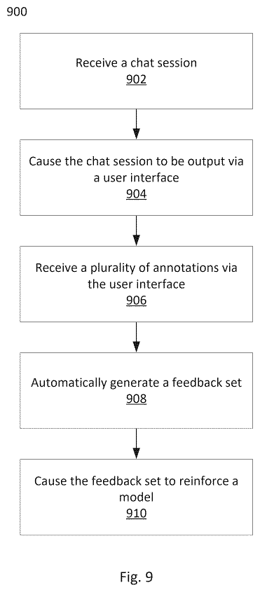

FIG. 9 is a flowchart of an example process 900. In some implementations, one or more process blocks of FIG. 9 may be performed by the computing device 100 and/or the server 120 in FIG. 1.

As shown in FIG. 9, process 900 may include receiving a chat session (block 902). For example, the computing device 100 may receive a chat session. As another example, the server 120 may receive a chat session. The chat session may comprise a plurality of turns. One or more of the turns may include a prompt and a response. The response may include probabilistic output generated by a model. The chat session may comprise data representing a human-model interaction. The chat session may comprise synthetic data. The chat session may comprise data representing an alteration of a human model interaction

As also shown in FIG. 9, process 900 may include causing the chat session to be output via a user interface (block 904). For example, the computing device 100 may cause the chat session to be output via a user device. As another example, the server 120 may cause the chat session to be output via a user interface.

As further shown in FIG. 9, process 900 may include receiving a plurality of annotations via the user interface (block 906). For example, the computing device 100 may receive a plurality of annotations via the user interface. As another example, the server 120 may receive a plurality of annotations via the user interface. One or more of the annotations may be associated with the one or more turns. The one or more annotations may indicate whether a corresponding turn comprises a positive response or a negative response. The receiving the plurality of annotations may comprise receiving a free text input via the user interface. The receiving the plurality of annotations may comprise causing a plurality of options to be presented via the user interface, and receiving an indication of a selection of one or more of the plurality of options. At least one of the one or more annotations may comprise a commentary. At least one aspect of the one or more annotations may be selected from good or bad. At least one aspect of the one or more annotations may be selected from professional or unprofessional. At least one aspect of the one or more annotations may be selected from helpful or unhelpful. At least one aspect of the one or more annotations is selected from relevant or irrelevant.

As also shown in FIG. 9, process 900 may include automatically generating a feedback set (block 908). For example, the computing device 100 may automatically generate a feedback set. As another example, the server 120 may automatically generate a feedback set. The feedback set may be automatically generated using at least a natural language processing (NLP) model. The feedback set may be based at least upon the one or more of the annotations. The feedback set may be associated with the one or more of the turns of the chat session. The feedback set may include a feedback prompt, a feedback response, and a feedback instruction. The feedback instruction may be based on a corresponding annotation. The automatically generating the feedback set may be automatically implemented in response to the receiving the plurality of annotations via the user interface.

As further shown in FIG. 9, process 900 may include causing the feedback set to reinforce the model (block 910). For example, the computing device 100 may cause the feedback set to reinforce the model. As another example, the server 120 may cause the feedback set to reinforce the model.
a) Process 900 may include receiving a user prompt associated with a second chat session from a user device. For example, the server 120 may receive a user prompt associated with a second chat session from a user device. Process 900 may include appending at least a portion of the feedback instruction to the user prompt associated with the second chat session to create an appended prompt. For example, the server 120 may append at least a portion of the feedback instruction to the user prompt associated with the second chat session to create an appended prompt. Process 900 may include causing the model to generate a second response based on at least the appended prompt. For example, the server 120 may cause the model to generate a second response based on at least the appended prompt. Process 900 may include causing the second response to be transmitted to the user device. For example, the server 120 may cause the second response to be transmitted to the user device.
b) Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

### EXAMPLE CLAUSES

Example Clause 1: A method may include: receiving a chat session with a plurality of turns, where one or more of the turns may include a prompt and a response, and where the response may include probabilistic output generated by a model; causing the chat session to be output via a user interface; receiving a plurality of annotations via the user interface, where one or more of the annotations is associated with the one or more of the turns, and where the one or more annotations may include a categorial annotation and a contextual annotation; generating, using at least a natural language processing (NLP) model and based at least upon the one or more of the annotations, a feedback set associated with the one or more of the turns of the chat session, where the feedback set may include a feedback prompt, a feedback response, and a feedback instruction; and causing the feedback set to reinforce the model.

Example Clause 2: The method of Example Clause 1, where the categorical annotation indicates whether a corresponding turn may include a positive response or a negative response.

Example Clause 3: The method of Example Clause 1 or Example Clause 2, where the feedback instruction may include categorical instruction and contextual instruction.

Example Clause 4: The method of any one of Example Clauses 1-3, where the categorical instruction is based on at least the categorical annotation and the contextual instruction is based on at least the contextual annotation.

Example Clause 5: The method of any one of Example Clauses 1-4, further may include: receiving a user prompt associated with a second chat session from a user device; appending at least a portion of the feedback instruction to the user prompt associated with the second chat session to create an appended prompt; causing the model to generate a second response based on at least the appended prompt; and causing the second response to be transmitted to the user device.

Example Clause 6: The method of any one of Example Clauses 1-5, where the receiving the plurality of annotations may include receiving a free text input via the user interface.

Example Clause 7: The method of any one of Example Clauses 1-6, where the receiving the plurality of annotations may include: causing a plurality of options to be presented via the user interface; and receiving an indication of a selection of one or more of the plurality of options.

Example Clause 8: The method of any one of Example Clauses 1-7, where the generating the feedback set is automatically implemented in response to the receiving the plurality of annotations via the user interface.

Example Clause 9: The method of any one of Example Clauses 1-8, where the contextual annotation may include a commentary relating to the categorical annotation.

Example Clause 10: The method of any one of Example Clauses 1-9, where the categorical annotation is selected from good or bad.

Example Clause 11: The method of any one of Example Clauses 1-10, where the categorical annotation is selected from professional or unprofessional.

Example Clause 12: The method of any one of Example Clauses 1-11, where the categorical annotation is selected from helpful or unhelpful.

Example Clause 13: The method of any one of Example Clauses 1-12, where the categorical annotation is selected from relevant or irrelevant.

Example Clause 14: The method of any one of Example Clauses 1-13, where the chat session may include data representing a human-model interaction.

Example Clause 15: The method of any one of Example Clauses 1-14, where the chat session may include synthetic data.

Example Clause 16: The method of any one of Example Clauses 1-15, where the chat session may include data representing an alteration of a human model interaction.

Example Clause 17: A method may include: receiving a chat session, where the chat session may include at least one turn, where the at least one turn may include at least a prompt and a response, and where the response may include probabilistic output generated by a model; receiving at least one annotation, where the at least one annotation is associated with the at least one turn, and where an annotation may include at least a categorial annotation and a contextual annotation; generating, based on the at least one annotation, at least one feedback set, where the at least one feedback set may include a feedback prompt, a feedback response, and a feedback instruction; and causing the at least one feedback set to be inputted to the model to finetune the model.

Example Clause 18: The method of Example Clause 17, where the at least one annotation is automatically created without human interaction.

Example Clause 19: The method of Example Clause 17 or Example Clause 18, where the at least one annotation is created manually.

Example Clause 20: The method of any one of Example Clauses 17-19, where the categorical annotation indicates whether a corresponding response may include a positive response or a negative response relative to an associated prompt.

Example Clause 21: The method of any one of Example Clauses 17-20, where the feedback instruction may include categorical instruction and contextual instruction.

Example Clause 22: The method of any one of Example Clauses 17-21, where the categorical instruction is based on at least the categorical annotation and the contextual instruction is based on at least the contextual annotation.

Example Clause 23: The method of any one of Example Clauses 17-22, further may include: receiving a user prompt associated with a second chat session from a user device; appending at least a portion of the feedback instruction to the user prompt associated with the second chat session to create an appended prompt; causing the model to generate a second response based on at least the appended prompt; and causing the second response to be transmitted to the user device.

Example Clause 24: The method of any one of Example Clauses 17-23, where the receiving the at least one annotation may include receiving a free text input via a user interface.

Example Clause 25: The method of any one of Example Clauses 17-24, where the receiving the at least one annotation may include: causing a plurality of options to be presented via a user interface; and receiving an indication of a selection of one or more of the plurality of options.

Example Clause 26: The method of any one of Example Clauses 17-25, where the generating the at least one feedback set is automatically implemented in response to the receiving the at least one annotation.

Example Clause 27: The method of any one of Example Clauses 17-26, where the contextual annotation may include a commentary relating to the categorical annotation.

Example Clause 28: The method of any one of Example Clauses 17-27, where the categorical annotation is selected from good or bad.

Example Clause 29: The method of any one of Example Clauses 17-28, where the categorical annotation is selected from professional or unprofessional.

Example Clause 30: The method of any one of Example Clauses 17-29, where the categorical annotation is selected from helpful or unhelpful.

Example Clause 31: The method of any one of Example Clauses 17-30, where the categorical annotation is selected from relevant or irrelevant.

Example Clause 32: The method of any one of Example Clauses 17-31, where the chat session may include data representing a human-model interaction.

Example Clause 33: The method of any one of Example Clauses 17-32, where the chat session may include synthetic data.

Example Clause 34: The method of any one of Example Clauses 17-33, where the chat session may include data representing an alteration of a human model interaction.

Example Clause 35: A method may include: receiving a chat session with a plurality of turns, where one or more of the turns may include a prompt and a response, and where the response may include probabilistic output generated by a model; causing the chat session to be output via a user interface; receiving a plurality of annotations via the user interface, where one or more of the annotations is associated with the one or more turns; automatically generating, using at least a natural language processing (NLP) model and based at least upon the one or more of the annotations, a feedback set associated with the one or more of the turns of the chat session, where the feedback set may include a feedback prompt, a feedback response, and a feedback instruction; and causing the feedback set to reinforce the model.

Example Clause 36: The method of Example Clause 35, where the one or more annotations indicate whether a corresponding turn may include a positive response or a negative response.

Example Clause 37: The method of Example Clause 35 or Example Clause 36, where the feedback instruction is based on a corresponding annotation.

Example Clause 38: The method of any one of Example Clauses 35-37, further may include: receiving a user prompt associated with a second chat session from a user device; appending at least a portion of the feedback instruction to the user prompt associated with the second chat session to create an appended prompt; causing the model to generate a second response based on at least the appended prompt; and causing the second response to be transmitted to the user device.

Example Clause 39: The method of any one of Example Clauses 35-38, where the receiving the plurality of annotations may include receiving a free text input via the user interface.

Example Clause 40: The method of any one of Example Clauses 35-39, where the receiving the plurality of annotations may include causing a plurality of options to be presented via the user interface, and receiving an indication of a selection of one or more of the plurality of options.

Example Clause 41: The method of any one of Example Clauses 35-40, where the automatically generating the feedback set is automatically implemented in response to the receiving the plurality of annotations via the user interface.

Example Clause 42: The method of any one of Example Clauses 35-41, where at least one of the one or more annotations may include a commentary.

Example Clause 43: The method of any one of Example Clauses 35-42, where at least one aspect of the one or more annotations is selected from good or bad.

Example Clause 44: The method of any one of Example Clauses 35-43, where at least one aspect of the one or more annotations is selected from professional or unprofessional.

Example Clause 45: The method of any one of Example Clauses 35-44, where at least one aspect of the one or more annotations is selected from helpful or unhelpful.

Example Clause 46: The method of any one of Example Clauses 35-45, where at least one aspect of the one or more annotations is selected from relevant or irrelevant.

Example Clause 47: The method of any one of Example Clauses 35-46, where the chat session may include data representing a human-model interaction.

Example Clause 48: The method of any one of Example Clauses 35-47, where the chat session may include synthetic data.

Example Clause 49: The method of any one of Example Clauses 35-48, where the chat session may include data representing an alteration of a human model interaction.

Example Clause 50: A system may include: one or more processors configured to: receive a chat session with a plurality of turns, where one or more of the turns may include a prompt and a response, and where the response may include probabilistic output generated by a model; cause the chat session to be output via a user interface; receive a plurality of annotations via the user interface, where one or more of the annotations is associated with the one or more of the turns, and where the one or more annotations may include a categorial annotation and a contextual annotation; generate, using at least a natural language processing (NLP) model and based at least upon the one or more of the annotations, a feedback set associated with the one or more of the turns of the chat session, where the feedback set may include a feedback prompt, a feedback response, and a feedback instruction; and cause the feedback set to reinforce the model.

Example Clause 51: The system of Example Clause 50, where the categorical annotation indicates whether a corresponding turn may include a positive response or a negative response.

Example Clause 52: The system of Example Clause 50 or Example Clause 51, where the feedback instruction may include categorical instruction and contextual instruction.

Example Clause 53: The system of any one of Example Clauses 50-52, where the categorical instruction is based on at least the categorical annotation and the contextual instruction is based on at least the contextual annotation.

Example Clause 54: The system of any one of Example Clauses 50-53, where the one or more processors are further configured to: receive a user prompt associated with a second chat session from a user device; append at least a portion of the feedback instruction to the user prompt associated with the second chat session to create an appended prompt; cause the model to generate a second response based on at least the appended prompt; and cause the second response to be transmitted to the user device.

Example Clause 55: The system of any one of Example Clauses 50-54, where the one or more processors are further configured to receive a free text input via the user interface.

Example Clause 56: The system of any one of Example Clauses 50-55, where the one or more processors are further configured to: cause a plurality of options to be presented via the user interface; and receive an indication of a selection of one or more of the plurality of options.

Example Clause 57: The system of any one of Example Clauses 50-56, where the generating the feedback set is automatically implemented in response to the receiving the plurality of annotations via the user interface.

Example Clause 58: The system of any one of Example Clauses 50-57, where the contextual annotation may include a commentary relating to the categorical annotation.

Example Clause 59: The system of any one of Example Clauses 50-58, where the categorical annotation is selected from good or bad.

Example Clause 60: The system of any one of Example Clauses 50-59, where the categorical annotation is selected from professional or unprofessional.

Example Clause 61: The system of any one of Example Clauses 50-60, where the categorical annotation is selected from helpful or unhelpful.

Example Clause 62: The system of any one of Example Clauses 50-61, where the categorical annotation is selected from relevant or irrelevant.

Example Clause 63: The system of any one of Example Clauses 50-62, where the chat session may include data representing a human-model interaction.

Example Clause 64: The system of any one of Example Clauses 50-63, where the chat session may include synthetic data.

Example Clause 65: The system of any one of Example Clauses 50-64, where the chat session may include data representing an alteration of a human model interaction.

Example Clause 66: A system may include: one or more processors configured to: receive a chat session, where the chat session may include at least one turn, where the at least one turn may include at least a prompt and a response, and where the response may include probabilistic output generated by a model; receive at least one annotation, where the at least one annotation is associated with the at least one turn, and where an annotation may include at least a categorial annotation and a contextual annotation; generate, based on the at least one annotation, at least one feedback set, where the at least one feedback set may include a feedback prompt, a feedback response, and a feedback instruction; and cause the at least one feedback set to be inputted to the model to finetune the model.

Example Clause 67: The system of Example Clause 66, where the at least one annotation is automatically created without human interaction.

Example Clause 68: The system of Example Clause 66 or Example Clause 67, where the at least one annotation is created manually.

Example Clause 69: The system of any one of Example Clauses 66-68, where the categorical annotation indicates whether a corresponding response may include a positive response or a negative response relative to an associated prompt.

Example Clause 70: The system of any one of Example Clauses 66-69, where the feedback instruction may include categorical instruction and contextual instruction.

Example Clause 71: The system of any one of Example Clauses 66-70, where the categorical instruction is based on at least the categorical annotation and the contextual instruction is based on at least the contextual annotation.

Example Clause 72: The system of any one of Example Clauses 66-71, where the one or more processors are further configured to: receive a user prompt associated with a second chat session from a user device; append at least a portion of the feedback instruction to the user prompt associated with the second chat session to create an appended prompt; cause the model to generate a second response based on at least the appended prompt; and cause the second response to be transmitted to the user device.

Example Clause 73: The system of any one of Example Clauses 66-72, where the one or more processors are further configured to receive a free text input via a user interface.

Example Clause 74: The system of any one of Example Clauses 66-73, where the one or more processors are further configured to: cause a plurality of options to be presented via a user interface; and receive an indication of a selection of one or more of the plurality of options.

Example Clause 75: The system of any one of Example Clauses 66-74, where the generating the at least one feedback set is automatically implemented in response to the receiving the at least one annotation.

Example Clause 76: The system of any one of Example Clauses 66-75, where the contextual annotation may include a commentary relating to the categorical annotation.

Example Clause 77: The system of any one of Example Clauses 66-76, where the categorical annotation is selected from good or bad.

Example Clause 78: The system of any one of Example Clauses 66-77, where the categorical annotation is selected from professional or unprofessional.

Example Clause 79: The system of any one of Example Clauses 66-78, where the categorical annotation is selected from helpful or unhelpful.

Example Clause 80: The system of any one of Example Clauses 66-79, where the categorical annotation is selected from relevant or irrelevant.

Example Clause 81: The system of any one of Example Clauses 66-80, where the chat session may include data representing a human-model interaction.

Example Clause 82: The system of any one of Example Clauses 66-81, where the chat session may include synthetic data.

Example Clause 83: The system of any one of Example Clauses 66-82, where the chat session may include data representing an alteration of a human model interaction.

Example Clause 84: A system may include: one or more processors configured to: receive a chat session with a plurality of turns, where one or more of the turns may include a prompt and a response, and where the response may include probabilistic output generated by a model; cause the chat session to be output via a user interface; receive a plurality of annotations via the user interface, where one or more of the annotations is associated with the one or more turns; automatically generate, using at least a natural language processing (NLP) model and based at least upon the one or more of the annotations, a feedback set associated with the one or more of the turns of the chat session, where the feedback set may include a feedback prompt, a feedback response, and a feedback instruction; and cause the feedback set to reinforce the model.

Example Clause 85: The system of Example Clause 84, where the one or more annotations indicate whether a corresponding turn may include a positive response or a negative response.

Example Clause 86: The system of Example Clause 84 or Example Clause 85, where the feedback instruction is based on a corresponding annotation.

Example Clause 87: The system of any one of Example Clauses 84-86, the one or more processors are further configured to: receive a user prompt associated with a second chat session from a user device; append at least a portion of the feedback instruction to the user prompt associated with the second chat session to create an appended prompt; cause the model to generate a second response based on at least the appended prompt; and cause the second response to be transmitted to the user device.

Example Clause 88: The system of any one of Example Clauses 84-87, where the one or more processors are further configured to receive a free text input via the user interface.

Example Clause 89: The system of any one of Example Clauses 84-88, where the one or more processors are further configured to: causing a plurality of options to be presented via the user interface; and receiving an indication of a selection of one or more of the plurality of options.

Example Clause 90: The system of any one of Example Clauses 84-89, where the automatically generating the feedback set is automatically implemented in response to the receiving the plurality of annotations via the user interface.

Example Clause 91: The system of any one of Example Clauses 84-90, where at least one of the one or more annotations may include a commentary.

Example Clause 92: The system of any one of Example Clauses 84-91, where at least one aspect of the one or more annotations is selected from good or bad.

Example Clause 93: The system of any one of Example Clauses 84-92, where at least one aspect of the one or more annotations is selected from professional or unprofessional.

Example Clause 94: The system of any one of Example Clauses 84-93, where at least one aspect of the one or more annotations is selected from helpful or unhelpful.

Example Clause 95: The system of any one of Example Clauses 84-94, where at least one aspect of the one or more annotations is selected from relevant or irrelevant.

Example Clause 96: The system of any one of Example Clauses 84-95, where the chat session may include data representing a human-model interaction.

Example Clause 97: The system of any one of Example Clauses 84-96, where the chat session may include synthetic data.

Example Clause 98: The system of any one of Example Clauses 84-97, where the chat session may include data representing an alteration of a human model interaction.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method comprising:
receiving a chat session with a plurality of turns, wherein one or more of the turns comprises a prompt and a response, and wherein the response comprises probabilistic output generated by a model;
causing the chat session to be output via a user interface;
receiving a plurality of annotations via the user interface, wherein one or more of the annotations is associated with the one or more of the turns, and wherein the one or more annotations comprises a categorial annotation and a contextual annotation;
generating, using at least a natural language processing (NLP) model and based at least upon the one or more of the annotations, a feedback set associated with the one or more of the turns of the chat session, wherein the feedback set comprises a feedback prompt, a feedback response, and a feedback instruction; and
causing the feedback set to reinforce the model.

2. The method of claim 1, wherein the categorical annotation indicates whether a corresponding turn comprises a positive response or a negative response.

3. The method of claim 1, wherein the feedback instruction comprises categorical instruction and contextual instruction.

4. The method of claim 3, wherein the categorical instruction is based on at least the categorical annotation and the contextual instruction is based on at least the contextual annotation.

5. The method of claim 1, further comprising:
receiving a user prompt associated with a second chat session from a user device;
appending at least a portion of the feedback instruction to the user prompt associated with the second chat session to create an appended prompt;
causing the model to generate a second response based on at least the appended prompt; and
causing the second response to be transmitted to the user device.

6. The method of claim 1, wherein the receiving the plurality of annotations comprises receiving a free text input via the user interface.

7. The method of claim 1, wherein the receiving the plurality of annotations comprises:
causing a plurality of options to be presented via the user interface; and
receiving an indication of a selection of one or more of the plurality of options.

8. The method of claim 1, wherein the generating the feedback set is automatically implemented in response to the receiving the plurality of annotations via the user interface.

9. The method of claim 1, wherein the contextual annotation comprises a commentary relating to the categorical annotation.

10. A method comprising:
receiving a chat session, wherein the chat session comprises at least one turn, wherein the at least one turn comprises at least a prompt and a response, and wherein the response comprises probabilistic output generated by a model;
receiving at least one annotation, wherein the at least one annotation is associated with the at least one turn, and wherein an annotation comprises at least a categorial annotation and a contextual annotation;
generating, based on the at least one annotation, at least one feedback set, wherein the at least one feedback set comprises a feedback prompt, a feedback response, and a feedback instruction; and
causing the at least one feedback set to be inputted to the model to finetune the model.

11. The method of claim 10, wherein the at least one annotation is automatically created without human interaction.

12. The method of claim 10, wherein the at least one annotation is created manually.

13. The method of claim 10, wherein the categorical annotation indicates whether a corresponding response comprises a positive response or a negative response relative to an associated prompt.

14. The method of claim 10, wherein the feedback instruction comprises categorical instruction and contextual instruction.

15. The method of claim 14, wherein the categorical instruction is based on at least the categorical annotation and the contextual instruction is based on at least the contextual annotation.

16. The method of claim 10, further comprising:
receiving a user prompt associated with a second chat session from a user device;
appending at least a portion of the feedback instruction to the user prompt associated with the second chat session to create an appended prompt;
causing the model to generate a second response based on at least the appended prompt; and
causing the second response to be transmitted to the user device.

17. A method comprising:
receiving a chat session with a plurality of turns, wherein one or more of the turns comprises a prompt and a response, and wherein the response comprises probabilistic output generated by a model;
causing the chat session to be output via a user interface;
receiving a plurality of annotations via the user interface, wherein one or more of the annotations is associated with the one or more turns;
automatically generating, using at least a natural language processing (NLP) model and based at least upon the one or more of the annotations, a feedback set associated with the one or more of the turns of the chat session, wherein the feedback set comprises a feedback prompt, a feedback response, and a feedback instruction; and
causing the feedback set to reinforce the model.

18. The method of claim 17, wherein the one or more annotations indicate whether a corresponding turn comprises a positive response or a negative response.

19. The method of claim 17, wherein the feedback instruction is based on a corresponding annotation.

20. The method of claim 17, further comprising:
receiving a user prompt associated with a second chat session from a user device;
appending at least a portion of the feedback instruction to the user prompt associated with the second chat session to create an appended prompt;
causing the model to generate a second response based on at least the appended prompt; and
causing the second response to be transmitted to the user device.
